(19) United States
(12) Patent Application Publication
(10) Pub. No.: US 2023/0354359 A1
(43) Pub. Date: Nov. 2, 2023

(54) UNIFIED TRANSMISSION CONFIGURATION INDICATORS IN MULTIPLE TRANSMISSION RECEPTION POINT ENVIRONMENTS

(71) Applicant: ZTE CORPORATION, Shenzhen (CN)

(72) Inventors: Ke YAO, Shenzhen (CN); Bo GAO, Shenzhen (CN); Chuangxin JIANG, Shenzhen (CN); Shujuan ZHANG, Shenzhen (CN); Zhaohua LU, Shenzhen (CN); Wenjun YAN, Shenzhen (CN)

(73) Assignee: ZTE CORPORATION, Shenzhen (CN)

(21) Appl. No.: 18/326,807

(22) Filed: May 31, 2023

Related U.S. Application Data
(63) Continuation of application No. PCT/CN2021/070819, filed on Jan. 8, 2021.

(51) Int. Cl. H04W 72/044; H04W 72/231

(52) U.S. Cl. CPC H04W 72/231; H04W 72/046

(57) ABSTRACT

Presented are systems, methods, apparatuses, or computer-readable media for unified transmission configuration indicators (TCIs) in multiple transmission reception point (MTRP) environments. A wireless communication device may receive, from a wireless communication node, downlink control information (DCI) indicating at least one beam state. The wireless communication device may determine a transmission resource according to the DCI. The wireless communication device may perform a transmission using the transmission resource.

### CROSS-REFERENCE TO RELATED APPLICATION

This application claims the benefit of priority under 35 U.S.C. § 120 as a continuation of PCT Patent Application No. PCT/CN2021/070819, filed on Jan. 8, 2021, the disclosure of which is incorporated herein by reference in its entirety.

### TECHNICAL FIELD

The disclosure relates generally to wireless communications, including but not limited to systems and methods for unified transmission configuration indicators (TCIs) in multiple transmission reception point (MTRP) environments.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium. A wireless communication device may receive, from a wireless communication node, downlink control information (DCI) indicating at least one beam state. The wireless communication device may determine a transmission resource according to the DCI. The wireless communication device may perform a transmission using the transmission resource.

In some embodiments, the transmission resource may include a control resource set (CORESET), a CORESET group, a physical uplink control channel (PUCCH) resource, a PUCCH resource group, a sounding reference signal (SRS) resource, a SRS resource set, or a SRS resource group.

In some embodiments, the wireless communication device may determine the transmission resource, according to the DCI, including at least one of: a transmission resource which is associated with the DCI, a transmission resource group which includes the transmission resource which is associated with the DCI, a transmission resource identified by a predefined or pre-configured target transmission resource identifier (ID) or a target transmission resource group ID, a transmission resource identified by a target transmission resource ID or a target transmission resource group ID indicated by the DCI or a medium access control control element (MAC CE) signaling, or at least one transmission resource which is not identified by a pre-configured target transmission resource ID or a target transmission resource group ID, or by a target transmission resource identifier or a target transmission resource group ID indicated by the DCI or a MAC CE signaling.

In some embodiments, the wireless communication device may determine the transmission resource, which comprises a control resource set (CORESET), according to at least one of: a CORESET which is associated with the DCI; a CORESET group which includes the CORESET which is associated with the DCI; a CORESET identified by a predefined or pre-configured CORESET identifier (ID) or CORESET group ID, or by a CORESET ID or CORESET group ID indicated by the DCI or a medium access control control element (MAC CE) signaling, or; at least one CORESET which is not identified by a predefined or pre-configured CORESET ID or CORESET group ID, or by a CORESET ID or CORESET group ID indicated by the DCI or a MAC CE signaling.

In some embodiments, the wireless communication device may determine the transmission resource, which comprises a physical uplink control channel (PUCCH) resource, according to at least one of: a PUCCH resource indicated by a PUCCH resource indicator (PRI) in the DCI; a PUCCH resource group which comprises a PUCCH resource indicated by the PRI in the DCI; a PUCCH resource identified by a predefined or pre-configured target PUCCH resource ID or a target PUCCH resource group ID; a PUCCH resource identified by a target PUCCH resource ID or a target PUCCH resource group ID indicated by the DCI or a medium access control control element (MAC CE) signaling; or at least one PUCCH resource which is not identified by a pre-configured target PUCCH resource ID or a target PUCCH resource group ID, or by a target PUCCH resource identifier or a target PUCCH resource group ID indicated by the DCI or a MAC CE signaling.

In some embodiments, the wireless communication device may determine the transmission resource, which includes a sounding reference signal (SRS) resource, according to at least one of: at least one SRS resource indicated by a SRS request field in the DCI; a SRS resource group which comprises a SRS resource indicated by a SRS request field in the DCI; a SRS resource identified by a predefined or pre-configured target SRS resource ID or a target SRS resource group ID; a SRS resource identified by a target SRS resource ID or a target SRS resource group ID indicated by the DCI or a medium access control control element (MAC CE) signaling; at least one SRS resource which is not identified by a pre-configured target SRS resource ID or a target SRS resource group ID, or by a target SRS resource ID or a target SRS resource group ID indicated by the DCI or a MAC CE signaling; or at least one SRS resource in at least one SRS resource set, with usage of codebook or non-codebook.

In some embodiments, the wireless communication device may determine the transmission resource, according to the DCI and a transmission information. In some embodiments, the wireless communication device may determine the transmission resource, according to the DCI and at least one of: a transmission resource which is associated with a transmission information corresponding to the at least one beam state indicated by the DCI, at least one first transmission information associated with the transmission resource that is same as or corresponds to at least one second transmission information which is associated with the at least one beam state indicated by the DCI, or at least one first transmission information associated with the transmission resource and at least one second transmission information associated with the at least one beam state indicated by the DCI that share at least one transmission information.

In some embodiments, the at least one first transmission information associated with the transmission resource may include: at least one transmission information associated with the transmission resource, or at least one transmission information associated with at least one beam state which is associated with the transmission resource.

In some embodiments, the at least one second transmission information which is associated with the at least one beam state indicated by the DCI, may include: at least one transmission information associated with the at least one beam state indicated by the DCI, or at least one transmission information indicated by the DCI for the at least one beam state indicated by the DCI.

In some embodiments, the wireless communication device may determine the transmission resource, which comprises a control resource set (CORESET), according to at least one of: a CORESET which is associated with at least one transmission information that is same as or corresponds to that associated with the at least one beam state indicated by the DCI; a CORESET group which includes the CORESET which is associated with the at least one transmission information that is same as or corresponds to that associated with the at least one beam state indicated by the DCI; or a CORESET with a lowest or a highest CORESET index among at least one CORESET which is associated with the at least one transmission information that is same as or corresponds to that associated with the at least one beam state indicated by the DCI.

In some embodiments, the wireless communication device may determine the transmission resource, which comprises a physical uplink control channel (PUCCH) resource, according to at least one of: a PUCCH resource which is associated with at least one transmission information that is same as or corresponds that associated with the at least one beam state indicated by the DCI; a PUCCH resource group which includes the PUCCH resource which is associated with the at least one transmission information that is same as or corresponds to that associated with the at least one beam state indicated by the DCI; or a PUCCH resource with a lowest or a highest PUCCH resource index among at least one PUCCH resource which is associated with at least one transmission information that is same as or corresponds to that associated with the at least one beam state indicated by the DCI.

In some embodiments, the wireless communication device may determine the transmission resource, which comprises a sounding reference signal (SRS) resource, according to at least one of: a SRS resource which is associated with at least one transmission information that is same as or corresponds to that associated with the at least one beam state indicated by the DCI; a SRS resource group which includes the SRS resource which is associated with the at least one transmission information that is same as or corresponds to that associated with the at least one beam state indicated by the DCI; or a SRS resource with a lowest or a highest SRS resource index among at least one SRS resource which is associated with the at least one transmission information that is same as or corresponds to that associated with the at least one beam state indicated by the DCI.

In some embodiments, the wireless communication device may determine at least one beam state applied to the transmission resource, from the at least one beam state indicated by the DCI. In some embodiments, the transmission resource may include a physical uplink control channel (PUCCH) resource. In some embodiments, the at least one beam state applied to the transmission resource may be associated with: the PUCCH resource, or a PUCCH spatial relation associated with the PUCCH resource.

In some embodiments, one or more power control parameters associated with the beam state may be associated with the PUCCH spatial relation associated with the PUCCH resource. In some embodiments, the transmission resource may include a sounding reference signal (SRS) resource. In some embodiments, the at least one beam state applied to the transmission resource from the at least one beam state indicated by the DCI, may be associated with the SRS resource.

In some embodiments, the wireless communication device may determine at least one beam state applied to the transmission resource, from the at least one beam state indicated by the DCI, according to the transmission information. In some embodiments, the transmission information may include or correspond to a transmission-reception point (TRP), a TRP identifier (ID), a panel, a control resource set (CORESET) pool identifier (ID), a physical cell ID (PCI), a transmission configuration indicator (TCI) state, a TCI state group, antenna group, a beam state or a beam state group.

In some embodiments, the wireless communication device may determine the at least one beam state applied to the transmission resource, from at least one beam state indicated by the DCI, which is associated with a transmission information corresponding to at least one transmission information. In some embodiments, the wireless communication device may determine the at least one beam state applied to the transmission resource, from at least one beam state indicated by the DCI which is associated with a transmission information that is same as or corresponds to at least one transmission information associated with the transmission resource.

In some embodiments, the wireless communication device may determine the at least one beam state applied to the transmission resource, from at least one beam state indicated by the DCI which is associated with a transmission information that is same as or corresponds to at least one transmission information associated with the transmission resource, if an old beam state associated with the transmission resource shares a transmission information that is same as or corresponds to the at least one transmission information associated with the transmission resource

In some embodiments, the transmission resource may include a control resource set (CORESET) or CORESET group, and the at least one beam state indicated by the DCI applied to the transmission resource is associated with the CORESET or CORESET group. In some embodiments, the transmission resource may include a physical uplink control channel (PUCCH) resource or PUCCH resource group, and the at least one beam state indicated by the DCI applied to the transmission resource is associated with the PUCCH resource or PUCCH resource group, or associated with a PUCCH spatial relation associated with the PUCCH resource or PUCCH resource group. In some embodiments, the transmission resource may include a sounding reference signal (SRS) resource or SRS resource group, and the at least one beam state indicated by the DCI applied to the transmission resource is associated with the SRS resource or SRS resource group.

At least one aspect is directed to a system, a method, an apparatus, or a computer-readable medium. A wireless communication node may transmit to a wireless communication device, downlink control information (DCI) indicating at least one beam state. The wireless communication node may cause the wireless communication device to determine a transmission resource according to the DCI. The wireless communication node may cause the wireless communication device to perform a transmission using the transmission resource.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader’s understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a block diagram of a system for determining a target physical downlink control channel (PDCCH) or a control resource set (CORESET) when a common beam state is applied in accordance with an illustrative embodiment;

FIG. 4 illustrates a block diagram of a system for determining a target physical uplink control channel (PUCCH) when a common transmission configuration indicator (TCI) state is applied in accordance with an illustrative embodiment;

FIG. 5 illustrates a block diagram of a system for a system for determining a target sounding reference signals (SRSs) when common transmission configuration indicator (TCI) state is applied to the SRS in accordance with an illustrative embodiment; and

FIG. 6 illustrates a flow diagram of a method for unified transmission configuration indicators (TCIs) in multiple transmission reception point (MTRP) environments in accordance with an illustrative embodiment.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

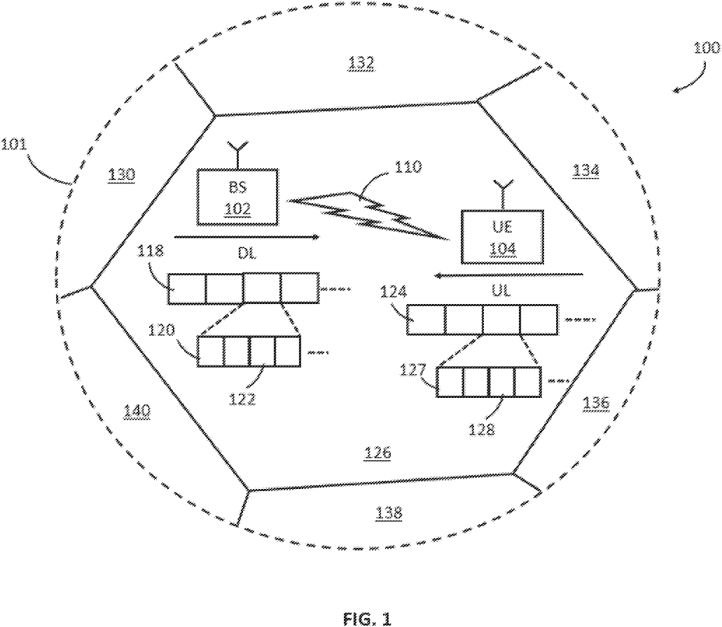

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/12 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

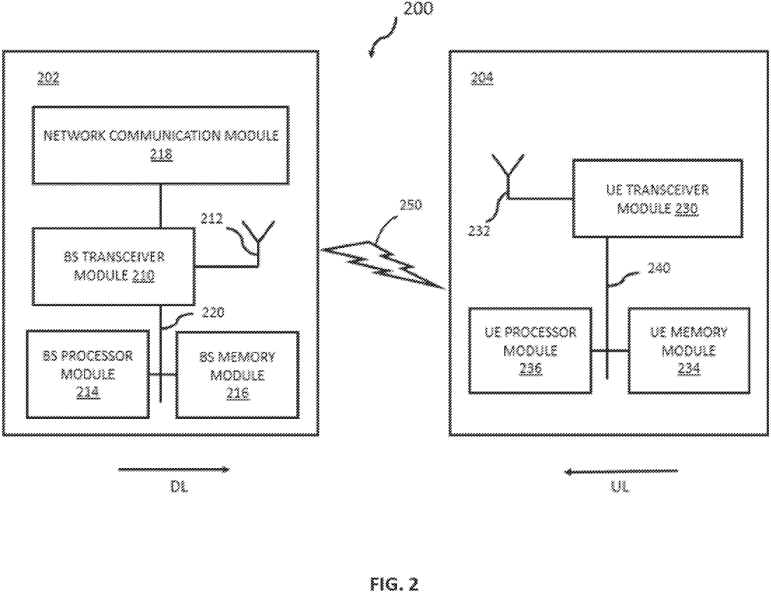

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Unified Transmission Configuration Indicators (TCIs) in Multiple Transmission Reception Point (MTRP) Environments

In multiple transmission reception point (MTPR) environments, there may be potentially at least two issues. First, one or two transmission configuration indicators (TCIs) indicated by downlink control information (DCI) may be applied to target channels or transmissions. On the other hand, a physical downlink control channel (PDCCH) and a physical uplink control channel (PUCCH) may be configured with one or two TCI, spatial relationships, or beams. Which TCI in the DCI is to be applied to a corresponding TCI, spatial relationship, or beam of PDCCH and PUCCH may be not clear. Second, in carrier aggregation (CA), when component carriers (CCs) are configured with different subcarrier spacings (SCSs), how to determine the effective time for the TCI in the DCI for the target channels may not be clear.

One feature in new radio (NR) technology of fifth generation (5G) mobile communication systems may be the support of high frequency bands. High frequency bands may have abundant frequency domain resources, but wireless signals in high frequency bands may decay quickly and coverage of the wireless signals may decrease. As such, transmitting signals in a beam mode may be able to concentrate energy in a relatively small spatial range and improve the coverage of the wireless signals in the high frequency bands. In the beam scenario, as the time and position change, a beam pair between a base station and a user equipment (UE) may also change. A flexible beam update mechanism may thus be desired. Under one approach, NR technology may support a beam mechanism with an assumption that the UE has a single panel or communicates with a single transmission and reception point (TRP). This mechanism may not be able to indicate the beams for multiple channels, multiple panels, or in a multiple TRPs scenario.

With unified TCI architecture, TCI state can be applied to uplink and downlink, data and control channels. For example, the beam state (also referred as TCI state, common TCI state, or common beam state) indicated by the DCI may be applied to at least one of multiple channels (e.g., a target transmission). The channel may include, for example, a physical downlink shared channel (PDSCH), physical downlink control channel (PDCCH), physical uplink control channel (PUCCH), physical uplink shared channels (PUSCH), sounding reference signal (SRS), or channel state information reference signal (CSI-RS), among others. The beam state may include quasi-co-location (QCL) information, a TCI state, spatial relation information, reference signal information, spatial filter information, or precoding information, among others. Carrier aggregation (CA) may include at least one component carrier (CC). A CC may include at least one bandwidth part (BWP). The configuration from a gNB to a UE may be in a CC, or in the BWP within a CC. A configuration in a CC may identify a configuration in one BWP or multiple configurations in multiple BWPs.

In detail, first, a target transmission resource may be determined with or without the TRP. In some embodiments, no TRP information may be used for the determination of the target resource according to DCI (e.g., a PUCCH resource indicator (PRI) or SRS request field in the DCI). In some embodiments, TRP may be used to determine the target resource. The TRP in this case may include both the TRP related to the target resource and the TRP related to the beam state in the DCI.

In some embodiments, the TRP related to the target resource may correspond to the TRP which is associated with the target resource or the TRP that is associated with the beam state corresponding to (or associated with) the target resource. In some embodiments, the TRP related to the beam state in the DCI may include the TRP that is associated with the beam state in the DCI or TRP that is indicated directly in the DCI corresponding to the beam state in the DCI. In some embodiments, the TRP may include the same TRP related to the target resource and the beam state in the DCI, or at least one TRP related to the target resource and the beam state in the DCI, among others.

Second, the beam state for the target resource may be determined with or without the TRP. In some embodiments, no TRP information may be used for determination of the beam state for the target resource according to the beam state in the DCI. In some embodiments, the TRP information may be used for determination of the beam state for the target resource. The beam state can be applied to the target resource only when they share the same TRP.

### A. Determining Target Physical Downlink Control Channel (PDCCH) or Control Resource Set (CORESET) When Common Beam State Is Applied to PDCCH or CORESET

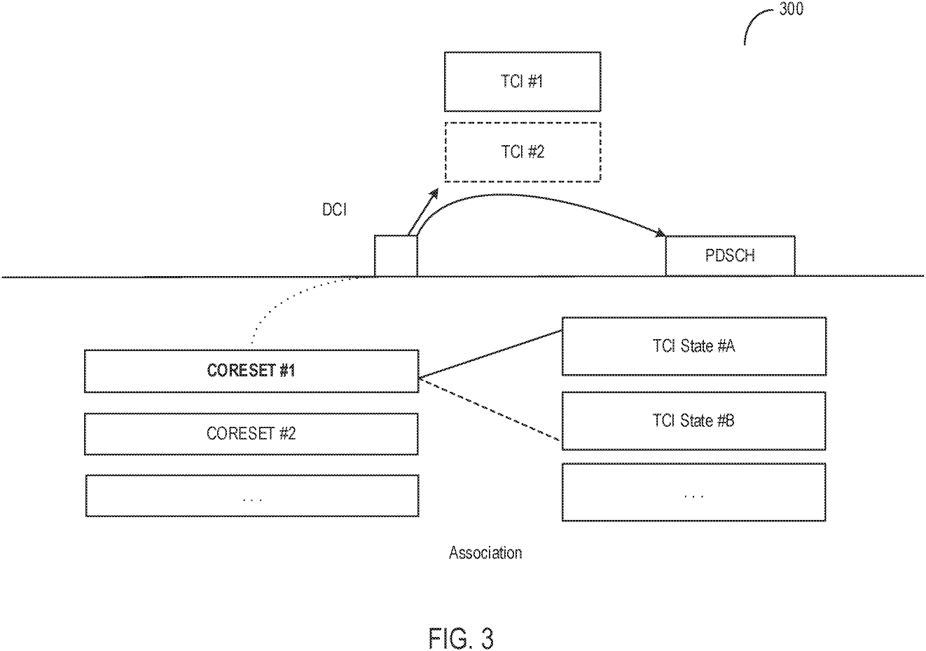

Referring now to FIG. 3, depicted is a block diagram of a system 300 for determining a target physical downlink control channel (PDCCH) or a control resource set (CORESET) when a common beam state is applied. A gNB may configure at least one control resource set (CORESET) for a UE. Each CORESET may be associated with one or two TCI states, and each TCI may correspond to a transmission reception point (TRP). The gNB may also configure at least one search space for the UE and each search space may be associated with a CORESET and downlink control information (DCI) format. Then, the gNB may transmit the DCI format in a corresponding search space, and the UE may receive the corresponding DCI in the search space. The PDCCH may be used to communicate the DCI. The DCI may be used to schedule or activate downlink (e.g., PDSCH) or uplink transmission (e.g., PUSCH). The transmission configuration indicator (TCI) state indicated by the DCI may be applied to the scheduled PDSCH or PUSCH transmission.

When common TCI state is applied to the PDCCH or CORESET, the target PDCCH or the CORESET may be determined in the following manner. A UE may receive a DCI from a gNB, in a first CORESET. A TCI state indicated by the DCI can be applied to a target CORESET. The target CORESET can be determined by at least one of the following, such as: the CORESET that is used to transmit the DCI; the CORESET group that contains the CORESET which is used to transmit the DCI; and the CORESET that is identified by a predefined or a pre-configured CORESET (group) ID, or a CORESET (group) ID indicated by the DCI or by a media access control, control element (MAC CE).

A predefined CORESET (group) ID may include a lowest or a highest CORESET (group) ID, e.g., in a bandwidth part (BWP) or a component carrier (CC). A pre-configured CORESET group ID may include a specific coresetPoolIndex. The CORESETs corresponding to a coresetPoolIndex may be referred as a CORESET pool. A CORESET pool may comprise one or more CORESET group which is identified by a CORESET group ID. A CORESET (group) ID indicated by the DCI or by a MAC CE can be used in the case that the quality of a CORESET is not sufficient (e.g., good enough) to transmit a DCI. Another CORESET can be used to transmit a DCI to convey a new TCI state for that not so good quality CORESET.

A gNB may configure the CORESET group for a UE. A CORESET group may include at least one CORESET, in one CC or across multiple CCs. When a CORESET group contains multiple CORESETs across multiple CCs, a DCI in each CC of the multiple CCs can cause a new TCI state to be used for a CORESET belonging to the CORESET group. For example, when a DCI in a first CC indicates a TCI state, the TCI state can be applied to a target CORESET that belongs to the CORESET group containing the CORESET that is used to transmit the DCI.

If the target CORESET is configured in a second CC, the TCI state indicated by the DCI in the first CC may be applied to the target CORESET. A TCI state configured in the second CC that has the TCI state ID as the TCI state ID indicated by the DCI in the first CC may also be applied to the target CORESET. The CORESET may be not identified by a predefined or a pre-configured CORESET (group) ID, or a CORESET (group) ID indicated by the DCI or by a MAC CE in a CC. In this case, a predefined or a pre-configured CORESET (group) ID, or a CORESET (group) ID indicated by the DCI or by a MAC CE may identify particular CORESET(s) that the TCI state in the DCI is not applied to. Except these particular CORESET(s), the remaining CORESET(s) in a CC can be applied to the TCI state indicated by the DCI.

There may be two DCI schemes to support multiple TRP (MTRP) for a gNB: S-DCI (single-DCI) and M-DCI (multiple-DCI). S-DCI may be designed when ideal backhaul is present between TRPs. In contrast, M-DCI may be for when ideal backhaul is not present. If there is ideal backhaul among the TRPs, information can be exchanged between the TRPs in time. With S-DCI, a DCI can indicate one TCI state from one TRP, or more TCI states each from a corresponding TRP. The DCI may be transmitted on PDCCH with a CORESET configured with a TCI state from a TRP. It can be described as a DCI is transmitted by a TRP.

When an S-DCI indicates a TCI state, the TRP of the TCI state may sometimes not be the same as the TRP that transmitted the DCI. As shown in table 1, TCI state codepoint may indicate a value 0 which means TCI state 1 is from TRPO, and this TCI state codepoint can be carried in a DCI transmitted by TRPO or TRP1. A value of 2 for TCI state codepoint indicates TCI state 1 and TCI state 2 can also be carried in a DCI transmitted by TRPO or TRP1.

TABLE 1

| | | |
|---|---|---|
| TCI state codepoint | TRP0 | TRP1 |
| 0 | TCI state 1 | |
| 1 | | TCI state 2 |
| 2 | TCI state 1 | TCI state 2 |
| ... | | |

For M-DCI scheme, CORESET of a TRP may be configured with a coresetPoolIndex which is a CORESET pool ID used to identify a TRP. A DCI can indicate a TCI state from the TRP that is used to transmit the DCI.

A TCI state from a TRP may refer to: the TCI state that has a downlink (DL) reference RS, and the DL reference RS corresponds to the TRP; or the TCI state that has an uplink (UL) reference RS and the UL reference RS corresponds to the TRP.

One of the following methods can be used to determine a target TCI state(s) for the target CORESET. For M-DCI scheme, a TCI state indicated by a DCI from a CORESET with a coresetPoolIndex or a TRP can be applied to a CORESET with the same coresetPoolIndex or the same TRP. For S-DCI scheme, there may be two methods. Under one approach, the TCI states indicated by the DCI may be the target TCI states for the target CORESET. Under another approach, the TCI states indicated by the DCI may be the target TCI states for the target CORESET based on TRP. A TCI state indicated by the DCI may be applied to replace the target TCI state that shares the same TRP with the TCI state indicated by the DCI for the target CORESET.

### I. TCI States Indicated by the DCI May be the Target TCI States for the Target CORESET.

In some embodiments, the target CORESET may be configured with one TCI state (e.g., an old TCI state) from a TRP, and the DCI may indicate one TCI state (e.g., a new TCI state). Then, the new TCI state may be associated with or may be applied to the target CORESET. The old TCI state and the new TCI state may share the same TRP, or may have the different TRPs.

In some embodiments, the target CORESET may be configured with two TCI states (e.g., old TCI states) from two TRPs, and the DCI may indicate one TCI state (e.g., new TCI state). The new TCI state may be associated with or may be applied to the target CORESET. The old TCI states may correspond to two TRPs and the new TCI state may correspond to one TRP.

In some embodiments, the target CORESET may be configured with one TCI state (e.g., old TCI state) from a TRP, and the DCI may indicate two TCI states (e.g., new TCI states). The new TCI states may be associated with or may be applied to the target CORESET. The old TCI state may correspond to one TRP and the new TCI states may correspond to two TRPs.

In some embodiments, the target CORESET may be configured with two TCI states (e.g., old TCI states) from two TRPs, and the DCI may indicate two TCI states (e.g., new TCI states). The new TCI states may be associated with or may be applied to the target CORESET. The old TCI state and the new TCI states may correspond to the same two TRPs.

### II. TCI States Indicated by the DCI May be the Target TCI States for the Target CORESET Based on TRP.

A TCI state indicated by the DCI can only be applied to replace the target or old TCI state that shares the same TRP with the TCI state indicated by the DCI for the target CORESET. In some embodiments, the target CORESET may be configured with one TCI state (e.g., old TCI state) from a TRP, and the DCI may indicate one TCI state (e.g., new TCI state). The new TCI state may be associated with or may be applied to the target CORESET when the old TCI state and the new TCI state share the same TRP.

In some embodiments, the target CORESET may be configured with two TCI states (e.g., old TCI states) from two TRPs, and the DCI may indicate one TCI state (e.g., new TCI state). The new TCI state may be associated with or may be applied to the target CORESET to replace the old TCI state which shares the same TRP with the new TCI state.

In some embodiments, the target CORESET may be configured with one TCI state (e.g., old TCI state) from a TRP, and the DCI may indicate two TCI states (e.g., new TCI states). One of the new TCI states that shares the same TRP with the old TCI state may be associated with or may be applied to the target CORESET.

In some embodiments, the target CORESET may be configured with two TCI states (e.g., old TCI states) from two TRPs, and the DCI may indicate two TCI states (e.g., new TCI states). The new TCI states may be associated with or may be applied to the target CORESET. The old TCI state and the new TCI states may correspond to the same two TRPs. Further, the new TCI state may replace the old TCI state in order of TRP, which means the new TCI state and the to-be-replaced old TCI state share the same TRP.

TRP can be linked with the concept of CORESET pool (ID), CORESET group (ID), PCI (physical cell ID), TCI state (group), or beam state (group). In some cases, the TRP can be replaced by the above concept. TCI state can be associated with a TRP. For example, a TRP ID can be configured in a TCI state.

### B. Determining the Target PUCCH When Common TCI State Applied to PUCCH

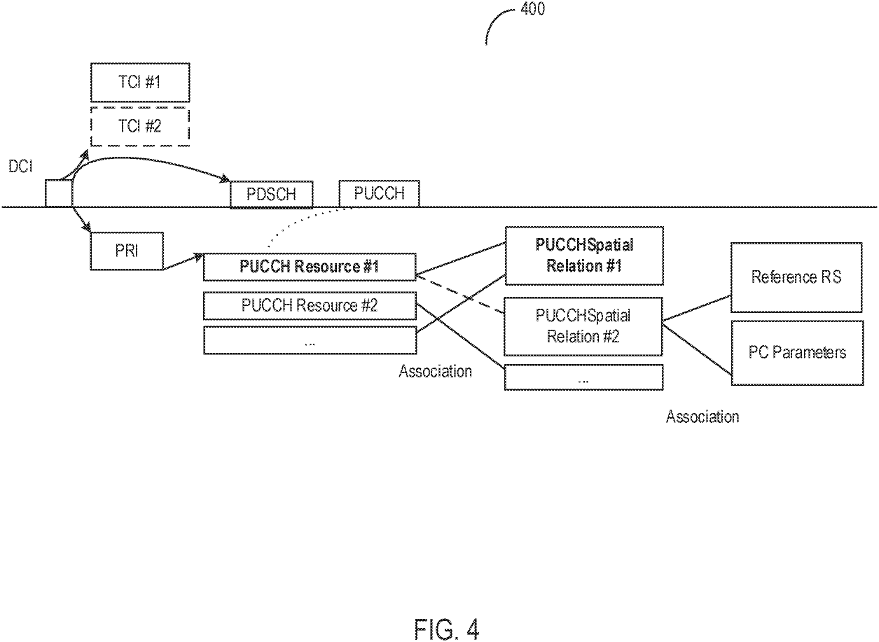

Referring now to FIG. 4, depicted is a block diagram of a system 400 for determining a target physical uplink control channel (PUCCH) when a common transmission configuration indicator (TCI) state is applied. To support MTRP downlink or uplink transmission, one or two TCI states can be indicated by DCI, meaning that the common TCI state can include one or two TCI states. For PUCCH transmission in the case of MTRP, one or two PUCCH spatial relations can be associated with a PUCCH resource. For PUCCH transmission in case of MTRP, DCI may indicate one or two PUCCH resources, and each PUCCH resource may be associated with one PUCCH spatial relation.

A TCI states indicated in a DCI (e.g., common TCI state) can be applied to a target PUCCH. For example, the common TCI state may be used to determine transmission parameters for PUCCH, such as a transmit beam or TCI state associated with the PUCCH. The target PUCCH can be determined by: a PUCCH resource indicated by a PUCCH resource indicator (PRI) in the DCI; or a PUCCH resource group that includes a PUSCH resource indicated by PRI in the DCI.

The common TCI state may be used to determine PUCCH spatial relation of the target PUCCH. In addition, all the PUCCHs related to the PUCCH spatial relation may be affected. A TCI state indicated in a DCI (e.g., common TCI state ) can be applied to a target PUCCH. The common TCI state may be associated with the PUCCH resource of the target PUCCH. The common TCI state may be associated with PUCCH spatial relation associated with the PUCCH resource of the target PUCCH. Further, the power control parameter associated with the common TCI state may be associated with PUCCH spatial relation associated with the PUCCH resource of the target PUCCH. A target PUCCH can be associated with one or two PUCCH resources.

### I. TCI States Indicated by DCI Associated With PUCCH Resource or PUCCH Spatial Relations Associated with PUCCH Resource of Target PUCCH

In some embodiments, the PUCCH resource may be be replaced by PUCCH spatial relation that is associated with the PUCCH resource. One PUCCH resource can be associated with a target PUCCH. Each PUCCH resource may be associated with one or two PUCCH spatial relations. For example, the PUCCH resource of the target PUCCH may be associated with one PUCCH spatial relation related to a TRP, and the DCI may indicate one TCI state (e.g., new TCI state). The new TCI state may be associated with or applied to the PUCCH resource of the target PUCCH. The PUCCH spatial relation and the new TCI state may share the same TRP, or may have the different TRPs.

In some embodiments, the PUCCH resource of the target PUCCH may be associated with two PUCCH spatial relations related to two TRPs, and the DCI may indicate one TCI state (e.g., a new TCI state). The new TCI state may be associated with or applied to the PUCCH resource of the target PUCCH. The PUCCH spatial relations may correspond to two TRPs and the new TCI state may correspond to one TRP.

In some embodiments, the PUCCH resource of the target PUCCH may be associated with one PUCCH spatial relation related to a TRP, and the DCI may indicate two TCI states (e.g., new TCI states). The new TCI states may be associated with or may be applied to the PUCCH resource of the target PUCCH. The PUCCH spatial relation may correspond to one TRP and the new TCI states may correspond to two TRPs.

In some embodiments, the PUCCH resource of the target PUCCH may be associated with two PUCCH spatial relation related to two TRPs, and the DCI may indicate two TCI states (e.g., new TCI states). The new TCI states may be associated with or may be applied to the PUCCH resource of the target PUCCH. The PUCCH spatial relations and the new TCI states may correspond to the same two TRPs.

One or two PUCCH resources can be associated with a target PUCCH, each PUCCH resource is associated with one PUCCH spatial relation. In some embodiments, a target PUCCH may correspond to one PUCCH resource that is associated with one PUCCH spatial relation related to a TRP, and the DCI indicates one TCI state (e.g., new TCI state), then the new TCI state is associated with or may be applied to the PUCCH resource of the target PUCCH. The PUCCH spatial relation and the new TCI state may share the same TRP, or may have the different TRPs.

In some embodiments, a target PUCCH may correspond to two PUCCH resources, each of which may be associated with one PUCCH spatial relation related to two TRPs, and the DCI may indicate one TCI state (e.g., new TCI state). The PUCCH spatial relations correspond to two TRPs and the new TCI state corresponds to one TRP. The new TCI state may be associated with or applied to one of the PUCCH resource of the target PUCCH. One of PUCCH resource of the target PUCCH can be the PUCCH resource with lower or higher PUCCH resource index or identifier (ID among the two PUCCH resources.

In some embodiments, the PUCCH resource of the target PUCCH may be associated with one PUCCH spatial relation related to a TRP, and the DCI may indicate two TCI states (e.g., new TCI states). The PUCCH spatial relation may correspond to one TRP and the new TCI states may correspond to two TRPs. Then one of the new TCI states may be associated with or may be applied to the PUCCH resource of the target PUCCH. One of the new TCI states can be the first or the last TCI state in TCI state codepoint.

In some embodiments, a target PUCCH may correspond to two PUCCH resources, each of which may be associated with one PUCCH spatial relation related to two TRPs, and the DCI may indicate two TCI states (e.g., new TCI states). The PUCCH spatial relations and the new TCI state may correspond to two TRPs. The new TCI states may be associated with or may be applied to the PUCCH resources of the target PUCCH.

### II. TCI States Indicated by DCI Associated With PUCCH Resource or PUCCH Spatial Relations Associated with PUCCH Resource of Target PUCCH Based on TRP

A TCI state indicated by the DCI can only be associated with PUCCH resource or PUCCH spatial relation of the target PUCCH. The PUCCH resource can be replaced by PUCCH spatial relation that is associated with PUCCH resource in all examples. One PUCCH resource can be associated with a target PUCCH. Each PUCCH resource may be associated with one or two PUCCH spatial relations.

In some embodiments, the PUCCH resource of the target PUCCH may be associated with one PUCCH spatial relation related to a TRP, and the DCI may indicate one TCI state (e.g., new TCI state). The new TCI state may be associated with or may be applied to the PUCCH resource of the target PUCCH in case that the PUCCH spatial relation and the new TCI state share the same TRP.

In some embodiments, the PUCCH resource of the target PUCCH may be associated with two PUCCH spatial relations related to two TRPs, and the DCI may indicate one TCI state (e.g., new TCI state). The PUCCH spatial relations may correspond to two TRPs and the new TCI state may correspond to one TRP. Then the new TCI state may be associated with or may be applied to the PUCCH resource of the target PUCCH which share the same TRP as the new TCI state.

In some embodiments, the PUCCH resource of the target PUCCH may be associated with one PUCCH spatial relation related to a TRP, and the DCI may indicate two TCI states (e.g., new TCI states). The PUCCH spatial relation may correspond to one TRP and the new TCI states may correspond to two TRPs. One of the new TCI states which shares the same TRP as the PUCCH spatial relation may be associated with or may be applied to the PUCCH resource of the target PUCCH.

In some embodiments, the PUCCH resource of the target PUCCH may be associated with two PUCCH spatial relation related to two TRPs, and the DCI may indicate two TCI states (e.g., new TCI states). The PUCCH spatial relations and the new TCI states may correspond to the same two TRPs. The new TCI states may be associated with or may be applied to the PUCCH resource of the target PUCCH. Further, the new TCI states may be associated with or may be applied to the PUCCH resource of the target PUCCH in order of TRP, which means the new TCI state and the PUCCH resource of the target PUCCH share the same TRP.

### C. Determining the Target SRS When Common TCI State is Applied to SRS

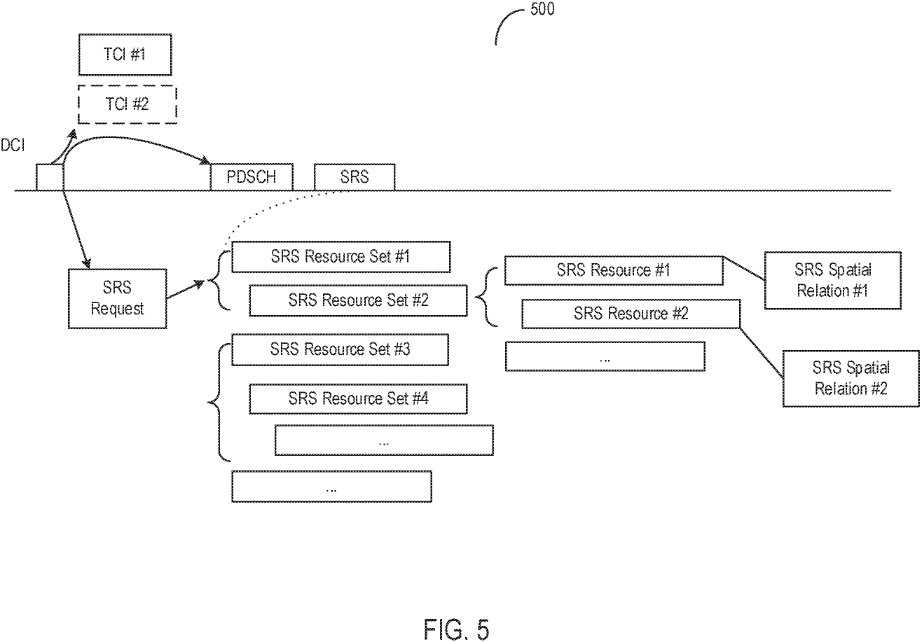

Referring now to FIG. 5, depicted is a block diagram of a system 500 for determining a target sounding reference signals (SRSs) when common transmission configuration indicator (TCI) state is applied to the SRS. A gNB may configure at least one SRS resource set for a UE. Each SRS resource set may include at least one SRS resource. Usage of SRS resource set can be one of: a beam management (BM), antenna switching (AS), codebook (CB) or non-codebook (NCB), among others. SRS resource in a SRS resource set with usage of CB and NCB is may be for codebook based PUSCH transmission and non-codebook based PUSCH transmission respectively.

To support MTRP downlink or uplink transmission, one or two TCI states can be indicated by a DCI, meaning the common TCI state can include one or two TCI states. For SRS transmission in case of MTRP, an SRS resource set may be associated with a TRP. A TCI states indicated in a DCI (e.g., common TCI state) can be applied to or associated with a target SRSs. For example, the common TCI state may be used to determine transmission parameters for SRS, such as transmit beam or TCI state associated with the SRS.

The target SRS can be determined by at least one of: a SRS resource(s) indicated by SRS request field in the DCI; or a SRS resource(s) in a SRS resource set(s) with usage of codebook or non-codebook. SRS request field in the DCI may indicate one or more SRS resource sets. The relation between SRS request field value and SRS resource set index or identifier (ID) may be configured by RRC signaling. The SRS resources indicated by SRS request field in the DCI may refer to all the SRS resources in SRS resource sets indicated by SRS request field in the DCI.

For the UE supported unified TCI applied for SRS, gNB can configure or indicate to enable or disable this function, meaning whether unified TCI applied for SRS is allowed or not. A TCI states indicated in a DCI (e.g., common TCI state) can be applied to or associated with a target SRSs in case that unified TCI applied for SRS is enabled. The common TCI state may be used to determine SRS spatial relation of the target SRS. The PUSCHs may refer to the SRS spatial relation are affected.

### I. TCI States Indicated by a DCI Can Be Applied to or Associated With SRS Resource of a Target SRS

If the target SRS includes the same number of SRS resource as the number of TCI states indicated by the DCI, TCI states indicated by a DCI can be applied to or associated with the SRS resource of the target SRS one by one. If the target SRS includes a less number of SRS resource than the number of TCI states indicated by the DCI, only the first N TCI states indicated by a DCI can be applied to or associated with the SRS resource of the target SRS one by one. N is the number of SRS resource of the target SRS.

If the target SRS includes a larger number of SRS resource than the number of TCI states indicated by the DCI, the TCI states indicated by a DCI can be applied to or associated with the first M SRS resources of the target SRS one by one. M is the number of TCI state(s) indicated by the DCI.

### II. TCI States Indicated by a DCI Applied to or Associated With Target SRS Based on TRP

A TCI state indicated by the DCI can only be applied to SRS resource that is related to the same TRP with the TCI state indicated by the DCI. TCI state can be associated with a TRP. SRS resource set can be associated with a TRP, then all the SRS resources in the SRS resource set are associated with the TRP. A group of SRS resources in an SRS resource set can be associated with a TRP, and another group of SRS resources in an SRS resource set can be associated with another TRP. A SRS resource can be associated with a TRP (e.g., through TCI state associated to SRS spatial relation of the SRS resource).

A TCI state indicated by the DCI can only be applied to SRS resource that is related to the same TRP with the TCI state indicated by the DCI. For example, the target SRS may include two SRS resources, which are associated with two different TRPs. TCI states indicated by the DCI can be applied to the SRS resources based on TRP. That means, if only one TCI state is indicated by the DCI, then this TCI state can be applied to the SRS resource associated with the same TRP as the one TCI state indicated by the DCI. If two TCI states are indicated by the DCI, then the two TCI states can be applied to the SRS resources in the order of the associated TRP.

In another example, the target SRS may include four SRS resources, which are associated with two different TRPs. The TCI state indicated by the DCI can be applied to the SRS resources based on TRP. In this case more than one SRS resource share the same TRP or SRS spatial relation or beam state, the SRS resources may have different number of ports. That means, if only one TCI state is indicated by the DCI, then this TCI state can be applied to the SRS resources associated with the same TRP as the one TCI state indicated by the DCI. If two TCI states are indicated by the DCI, then the two TCI states can be applied to the SRS resources in the order of the associated TRP.

Note that when a TCI state referring to a DL RS (e.g. CSI-RS, SSB) applied to an UL transmission (e.g. PUSCH, PUCCH, or SRS), a QCL type-D RS of the TCI state is applied to the UL transmission. When a TCI state referring to a UL RS (e.g. SRS) applied to an DL transmission (e.g. PDCCH, PDSH, or CSI-RS), a QCL type-D RS of the TCI state is applied to the DL transmission.

Note that the definition of “beam state group” is that different Tx beams within one group can be simultaneously received or transmitted, and/or Tx beams between different groups may NOT be simultaneously received or transmitted. Furthermore, the definition of “beam state group” is described from the UE perspective.

Note that the definition of “antenna group” is that different Tx beams within one group may NOT be simultaneously received or transmitted, and/or Tx beams between different groups can be simultaneously received or transmitted.

Furthermore, the definition of “antenna group” is that more than N different Tx beams within one group can NOT be simultaneously received or transmitted, and/or no more than N different Tx beams within one group can be simultaneously received or transmitted, where N is positive integer.

Furthermore, the definition of “antenna group” is that Tx beams between different groups can be simultaneously received or transmitted.

Furthermore, the definition of “antenna group” is described from the UE perspective.

Furthermore, the antenna group is equivalent to antenna port group, panel or UE panel. Furthermore, antenna group switching is equivalent to panel switching.

Notes that, in this patent, the group related conception is equivalent to “information grouping one or more reference signals”, “resource set”, “panel”, “sub-array”, “antenna group”, “antenna port group”, “group of antenna ports”, “beam group”, “transmission entity/unit”, or “reception entity/unit”. Furthermore, the group related conception is to represent the UE panel and some features related to the UE panel. Furthermore, the group related conception is equivalent to “group state” or “group ID”.

### D. Process for Unified Transmission Configuration Indicators (TCIs) in Multiple Transmission Reception Point (MTRP) Environments

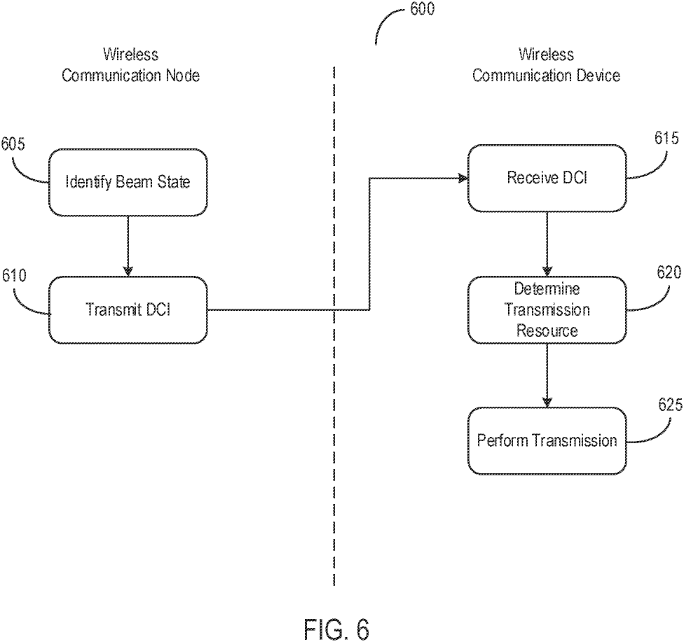

Referring now to FIG. 6, depicted is a flow diagram of a method 600 for unified transmission configuration indicators (TCIs) in multiple transmission reception point (MTRP) environments. The method 600 may be performed by or implemented using any of the components discussed above, such as the BS 102, UE 104, BS 202, or the UE 204, among others. In brief overview, a wireless communication node may identify a beam state (605). The wireless communication node may transmit downlink control information (DCI) (610). A wireless communication device may receive the DCI (615). The wireless communication device may determine a transmission resource (620). The wireless communication device may perform transmission (625).

In further detail, a wireless communication node (e.g., BS 102 or BS 202) may determine or identify a beam state for a wireless communication device (e.g., UE 104 or 204) (605). The beam state may identify, define, or otherwise include one or more parameters for a beam to be used by the wireless communication device in communication with the wireless communication node. The beam state may include quasi-co-location (QCL) information, a transmission configuration indicator (TCI) state, spatial relation information, reference signal information, spatial filter information, or precoding information, among others.

The wireless communication node may send, provide, or otherwise transmit downlink control information (DCI) to the wireless communication device (610). The DCI may identify, include, or otherwise indicate the beam state to be used. With the identification of the beam state, the wireless communication node may generate the DCI to indicate the beam state to the wireless communication device. The wireless communication device may retrieve, identify, or otherwise receive the DCI from the wireless communication node (615). Upon receipt, the wireless communication device may parse the DCI to extract or identify the beam state indicated by the DCI.

The wireless communication device may identify or determine a transmission resource in accordance with the DCI (620). In some embodiments, the wireless communication device may determine the transmission resource using the beam state indicated by the DCI. The transmission resource may include or correspond to a frequency domain or time resource allotted for communications between wireless communication device and the wireless communication node. The transmission resource may be related to, may correspond to, or may otherwise include a control resource set (CORESET), a CORESET group, a physical uplink control channel (PUCCH) resource, a PUCCH resource group, a sounding reference signal (SRS) resource, a SRS resource set, or a SRS resource group, among others. In some embodiments, the transmission resource may be associated with transmission information that is same as or corresponds to the beam state indicated by the DCI from the wireless communication node. In some embodiments, the transmission resource may lack any association with the transmission information.

The wireless communication device may determine the transmission resource according to the DCI without the transmission information. In some embodiments, the wireless communication device may determine the transmission resource associated with the DCI or a transmission resource group that identifies or includes the transmission resource associated with the DCI. In some embodiments, the wireless communication device may determine a transmission resource identified by a predefined or pre-configured target transmission resource identifier (ID) or a target transmission resource group ID. In some embodiments, the wireless communication device may determine a transmission resource identified by a target transmission resource ID, a target transmission resource group ID indicated by the DCI, or a medium access control control element (MAC CE) signaling. In some embodiments, the wireless communication device may determine at least one transmission resource which is not identified by a pre-configured target transmission resource ID or a target transmission resource group ID, or by a target transmission resource identifier or a target transmission resource group ID indicated by the DCI or a MAC CE signaling, among others. The target transmission resource ID may identify the transmission resource to be used. The target transmission resource group ID may identify the transmission resource group including the transmission resource.

In some embodiments, the wireless communication device may determine the transmission resource including the CORESET. The CORESET may correspond to, identify, or include frequency domain or time resources to carry communications between the wireless communication device and the wireless communication node. In some embodiments, the wireless communication device may determine a CORESET associated with the DCI or a CORESET group that includes the CORESET. The CORESET associated with the DCI may refer to a CORESET in which the DCI is received by the wireless communication device. The CORESET may also refer to a physical downlink control channel (PDCCH) via which the DCI is received by the wireless communication device. In some embodiments, the wireless communication device may determine a CORESET identified by a predefined or pre-configured CORESET identifier (ID) or CORESET group ID, or by a CORESET ID or CORESET group ID indicated by the DCI or a medium access control control element (MAC CE) signaling. In some embodiments, the wireless communication device may determine at least one CORESET which is not identified by a predefined or pre-configured CORESET ID or CORESET group ID, or by a CORESET ID or CORESET group ID indicated by the DCI or a MAC CE signaling. The CORESET ID may identify the CORESET to be used. The CORESET group ID may identify the CORESET group including the CORESET.

In some embodiments, the wireless communication device may determine the transmission resource including a physical uplink control channel (PUCCH) resource. The PUCCH resource may correspond to or include frequency domain or time resource to be used in the PUCCH. In some embodiments, the wireless communication device may determine a PUCCH resource indicated by a PUCCH resource indicator (PRI) in the DCI. In some embodiments, the wireless communication device may determine a PUCCH resource group that includes a PUCCH resource indicated by the PRI in the DCI. The PRI may identify or indicate the PUCCH resource to be used in the PUCCH between the wireless communication device and the wireless communication node. In some embodiments, the wireless communication device may determine a PUCCH resource identified by a predefined or pre-configured target PUCCH resource ID or a target PUCCH resource group ID. In some embodiments, the wireless communication device may determine a PUCCH resource identified by a target PUCCH resource ID or a target PUCCH resource group ID indicated by the DCI or a medium access control control element (MAC CE) signaling. In some embodiments, the wireless communication device may determine at least one PUCCH resource which is not identified by a pre-configured target PUCCH resource ID or a target PUCCH resource group ID, or by a target PUCCH resource identifier or a target PUCCH resource group ID indicated by the DCI or a MAC CE signaling. The target PUCCH resource ID may identify the PUCCH resource to be used in the PUCCH. The target PUCCH resource group ID may identify the PUCCH resource group that includes the PUCCH resource.

In some embodiments, the wireless communication device may determine the transmission resource including a sounding reference signal (SRS) resource. The SRS resource may correspond to or include a location of SRS in frequency domain or time. In some embodiments, the wireless communication device may determine at least one SRS resource indicated by a SRS request field in the DCI. In some embodiments, the wireless communication device may determine a SRS resource group which comprises a SRS resource indicated by a SRS request field in the DCI. In some embodiments, the wireless communication device may determine a SRS resource identified by a predefined or pre-configured target SRS resource ID or a target SRS resource group ID. In some embodiments, the wireless communication device may determine a SRS resource identified by a target SRS resource ID or a target SRS resource group ID indicated by the DCI or a medium access control control element (MAC CE) signaling. In some embodiments, the wireless communication device may determine at least one SRS resource which is not identified by a pre-configured target SRS resource ID or a target SRS resource group ID, or by a target SRS resource ID or a target SRS resource group ID indicated by the DCI or a MAC CE signaling. In some embodiments, the wireless communication device may determine at least one SRS resource in at least one SRS resource set, with usage of codebook or non-codebook. The target SRS resource ID may identify the SRS resource to be used. The target SRS resource group ID may identify the SRS resource group that includes the SRS resource.

The wireless communication device may determine the transmission resource according to the DCI together with the transmission information. In some embodiments, the wireless communication device may determine the transmission resource according to the DCI and a transmission resource which is associated with a transmission information corresponding to the at least one beam state indicated by the DCI. In some embodiments, the wireless communication device may determine the transmission resource according to the DCI and at least one first transmission information associated with the transmission resource that is same as or corresponds to at least one second transmission information associated with the at least one beam state indicated by the DCI. The transmission resource that is the same as or correspond to the at least one second transmission information may be associated with the beam state indicated in the DCI. In some embodiments, the wireless communication device may determine the transmission resource according to the DCI and at least one first transmission information associated with the transmission resource and at least one second transmission information which is associated with the at least one beam state indicated by the DCI that share at least one transmission information. The transmission resource may correspond to an intersection of the first transmission information and the second transmission information.

In some embodiments, the at least one first transmission information associated with the transmission resource may include at least one transmission information associated with the transmission resource. In some embodiments, the at least one first transmission information associated with the transmission resource may include at least one transmission information associated with at least one beam state which is associated with the transmission resource. In some embodiments, the at least one second transmission information which is associated with the at least one beam state indicated by the DCI may include at least one transmission information associated with the at least one beam state indicated by the DCI. In some embodiments, the at least one second transmission information which is associated with the at least one beam state indicated by the DCI may include at least one transmission information indicated by the DCI for the at least one beam state indicated by the DCI.

In some embodiments, the wireless communication device may determine the transmission resource include a control resource set (CORESET) using the transmission information. The CORESET may correspond to, identify, or include frequency domain or time resources to carry communications between the wireless communication device and the wireless communication node. In some embodiments, the wireless communication device may determine a CORESET that is associated with at least one transmission information that is same as or corresponds to that associated with the at least one beam state indicated by the DCI. In some embodiments, the wireless communication device may determine a CORESET group that includes the CORESET which is associated with the at least one transmission information that is same as or corresponds to that associated with the at least one beam state indicated by the DCI. In some embodiments, the wireless communication device may determine a CORESET with a lowest or a highest CORESET index among at least one CORESET which is associated with the at least one transmission information that is same as or corresponds to that associated with the at least one beam state indicated by the DCI. The CORESET index may identify a corresponding CORESET within the CORESET group. In some embodiments, the wireless communication device may determine a target beam state indicated by the DCI. The target beam state (e.g., one of old beam state(s) of the target transmission resource) may be a beam state of a CORESET that shares the same transmission information with beam state in DCI, and the target beam state (e.g., old beam state) may be updated by a corresponding beam state in DCI.

In some embodiments, the wireless communication device may determine the transmission resource including a physical uplink control channel (PUCCH) resource using the transmission information. The PUCCH resource may correspond to or include frequency domain or time resource to be used in the PUCCH. In some embodiments, the wireless communication device may determine a PUCCH resource which is associated with at least one transmission information that is same as or corresponds that associated with the at least one beam state indicated by the DCI. In some embodiments, the wireless communication device may determine a PUCCH resource group which includes the PUCCH resource that is associated with the at least one transmission information that is same as or corresponds to that associated with the at least one beam state indicated by the DCI. In some embodiments, the wireless communication device may determine a PUCCH resource with a lowest or a highest PUCCH resource index among at least one PUCCH resource which is associated with at least one transmission information that is same as or corresponds to that associated with the at least one beam state indicated by the DCI. The PUCCH resource index may identify a corresponding PUCCH resource.

In some embodiments, the wireless communication device may determine the transmission resource including a sounding reference signal (SRS) resource using the transmission information. The SRS resource may correspond to or include a location of SRS in frequency domain or time. In some embodiments, the wireless communication device may determine a SRS resource which is associated with at least one transmission information that is same as or corresponds to that associated with the at least one beam state indicated by the DCI. For the case that a DCI is transmitted in a CORESET associated with a first TRP, but the beam state indicated by the DCI is associated with a second TRP, the beam state indicated by the DCI may be used to update a CORESET which is associated with the second TRP, rather than the CORESET which is associated with the first TRP. In some embodiments, the wireless communication device may determine a SRS resource group which includes the SRS resource that is associated with the at least one transmission information that is same as or corresponds to that associated with the at least one beam state indicated by the DCI. In some embodiments, the wireless communication device may determine a SRS resource with a lowest or a highest SRS resource index among at least one SRS resource that is associated with the at least one transmission information that is same as or corresponds to that associated with the at least one beam state indicated by the DCI.

In some embodiments, the wireless communication device may identify or otherwise determine at least one beam state applied to the transmission resource from the at least one beam state indicated by the DCI. The beam state may be applied to the target CORESET, the target PUCCHs, or the target SRSs. In some embodiments, the transmission resource may identify or include a physical uplink control channel (PUCCH) resource. The beam state may be applied to the target PUCCH associated with the PUCCH resource. In some embodiments, the at least one beam state applied to the transmission resource may be associated with the PUCCH resource, or a PUCCH spatial relation associated with the PUCCH resource, among others. The beam state may be associated with the PUCCH spatial relation associated with the PUCCH resource of the target PUCCH. In some embodiments, one or more power control parameters associated with the beam state may be associated associated with the PUCCH spatial relation associated with the PUCCH resource. The power control parameters may include values for controlling power (e.g., p0 and alpha) in communications via the PUCCH between the wireless communication node and the wireless communication device. In some embodiments, the transmission resource may include a sounding reference signal (SRS) resource. The at least one beam state applied to the transmission resource from the at least one beam state indicated by the DCI, may be associated with the SRS resource.

In some embodiments, the wireless communication device may identify or determine at least one beam state applied to the transmission resource, from the at least one beam state indicated by the DCI, according to the transmission information. In some embodiments, the transmission information may include or correspond to a transmission-reception point (TRP), a TRP identifier (ID), a panel, a control resource set (CORESET) pool identifier (ID), a physical cell ID (PCI), a transmission configuration indicator (TCI) state, a TCI state group, antenna group, a beam state or a beam state group, among others. The TRP may correspond to or include the transmission information as discussed above.

In some embodiments, the wireless communication device may identify or determine the at least one beam state applied to the transmission resource, from at least one beam state indicated by the DCI. The DCI may be associated with a transmission information corresponding to at least one transmission information. the wireless communication device may identify or determine the at least one beam state applied to the transmission resource, from at least one beam state indicated by the DCI. The DCI may be associated with a transmission information that is same as or corresponds to at least one transmission information associated with the transmission resource. In some embodiments, the wireless communication device may determine the at least one beam state applied to the transmission resource, from at least one beam state indicated by the DCI, if an old beam state associated with the transmission resource shares a transmission information that is same as or corresponds to the at least one transmission information associated with the transmission resource. The DCI may be associated with a transmission information that is same as or corresponds to at least one transmission information associated with the transmission resource,

In some embodiments, the transmission resource may include a control resource set (CORESET) or CORESET group, and the at least one beam state indicated by the DCI applied to the transmission resource may be associated with the CORESET or CORESET group. In some embodiments, the transmission resource may include a physical uplink control channel (PUCCH) resource or PUCCH resource group. The at least one beam state indicated by the DCI applied to the transmission resource may be associated with the PUCCH resource or PUCCH resource group, or associated with a PUCCH spatial relation associated with the PUCCH resource or PUCCH resource group. In some embodiments, the transmission resource may include a sounding reference signal (SRS) resource or SRS resource group, and the at least one beam state indicated by the DCI applied to the transmission resource may be associated with the SRS resource or SRS resource group.

The wireless communication device may carry out, execute, or otherwise perform transmission with the wireless communication node using the transmission resource (625). Performing the transmission may correspond to or include communications (e.g., transmission and reception) between the wireless communication device and the wireless communication node. In performing the transmission, the wireless communication device may communicate with the wireless communication node using the PUCCH resource (or group), the CORESET (or group), SRS resource (or group), among others. In some embodiments, the wireless communication device may communicate according to the CORESET or CORESET group determined using the DCI (with or without the transmission information). In some embodiments, the wireless communication device may communicate according to the PUCCH resource or PUCCH resource group determined using the DCI (with or without the transmission information). In some embodiments, the wireless communication device may communicate according to the SRS resource determined using the DCI (with or without the transmission information).

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a wireless communication device from a wireless communication node, downlink control information (DCI) indicating at least one beam state;
determining, by the wireless communication device, a transmission resource according to the DCI;
determining, by the wireless communication device, at least one beam state applied to the transmission resource, from the at least one beam state indicated by the DCI, according to transmission information; and
performing, by the wireless communication device, a transmission using the transmission resource.

2. The method of claim 1, wherein the transmission resource comprises a control resource set (CORESET), a CORESET group, a physical uplink control channel (PUCCH) resource, a PUCCH resource group, a sounding reference signal (SRS) resource, a SRS resource set, or a SRS resource group.

3. The method of claim 1, wherein determining, by the wireless communication device, the transmission resource, according to the DCI, comprises determining at least one of:
a transmission resource which is associated with the DCI,
a transmission resource group which includes the transmission resource which is associated with the DCI,
a transmission resource identified by a predefined or pre-configured target transmission resource identifier (ID) or a target transmission resource group ID,
a transmission resource identified by a target transmission resource ID or a target transmission resource group ID indicated by the DCI or a medium access control control element (MAC CE) signaling, or
at least one transmission resource which is not identified by a pre-configured target transmission resource ID or a target transmission resource group ID, or by a target transmission resource ID or a target transmission resource group ID indicated by the DCI or a MAC CE signaling.

4. The method of claim 1, comprising:
determining, by the wireless communication device, the transmission resource, according to the DCI and a transmission information.

5. The method of claim 1, comprising determining, by the wireless communication device, the transmission resource, according to the DCI and at least one of:
a transmission resource which is associated with a transmission information corresponding to the at least one beam state indicated by the DCI;
at least one first transmission information associated with the transmission resource that is same as or corresponds to at least one second transmission information which is associated with the at least one beam state indicated by the DCI, or
at least one first transmission information associated with the transmission resource and at least one second transmission information associated with the at least one beam state indicated by the DCI that share at least one transmission information.

6. The method of claim 1, comprising:
determining, by the wireless communication device, the transmission resource, which comprises a control resource set (CORESET), according to:
a CORESET which is associated with at least one transmission information that is same as or corresponds to that associated with the at least one beam state indicated by the DCI; or
determining, by the wireless communication device, the transmission resource, which comprises a physical uplink control channel (PUCCH) resource, according to:
a PUCCH resource which is associated with at least one transmission information that is same as or corresponds that associated with the at least one beam state indicated by the DCI; or
determining, by the wireless communication device, the transmission resource, which comprises a sounding reference signal (SRS) resource, according to:
a SRS resource which is associated with at least one transmission information that is same as or corresponds to that associated with the at least one beam state indicated by the DCI.

7. The method of claim 1, wherein the transmission information comprises or corresponds to a transmission-reception point (TRP), a TRP identifier (ID), a panel, a control resource set (CORESET) pool identifier (ID), a physical cell ID (PCI), a transmission configuration indicator (TCI) state, a TCI state group, antenna group, a beam state or a beam state group.

8. The method of claim 1, comprising:
determining the at least one beam state applied to the transmission resource from at least one beam state indicated by the DCI which is associated with a transmission information that is same as or corresponds to at least one transmission information associated with the transmission resource.

9. The method of claim 1, comprising:
determining the at least one beam state applied to the transmission resource, from at least one beam state indicated by the DCI which is associated with a transmission information that is same as or corresponds to at least one transmission information associated with the transmission resource, if an old beam state associated with the transmission resource shares a transmission information that is same as or corresponds to the at least one transmission information associated with the transmission resource.

10. The method of claim 1, wherein:
the transmission resource comprises a control resource set (CORESET) or CORESET group, and the at least one beam state indicated by the DCI applied to the transmission resource is associated with the CORESET or CORESET group;
the transmission resource comprises a physical uplink control channel (PUCCH) resource or PUCCH resource group, and the at least one beam state indicated by the DCI applied to the transmission resource is associated with the PUCCH resource or PUCCH resource group, or associated with a PUCCH spatial relation associated with the PUCCH resource or PUCCH resource group; or
the transmission resource comprises a sounding reference signal (SRS) resource or SRS resource group, and the at least one beam state indicated by the DCI applied to the transmission resource is associated with the SRS resource or SRS resource group.

11. A wireless communication device comprising:
at least one processor configured to:
receive, via a receiver from a wireless communication node, downlink control information (DCI) indicating at least one beam state;
determine a transmission resource according to the DCI;
determine at least one beam state applied to the transmission resource, from the at least one beam state indicated by the DCI, according to transmission information; and
perform a transmission using the transmission resource.

12. A wireless communication node comprising:
at least one processor configured to:
transmit, via a transmitter to a wireless communication device, downlink control information (DCI) indicating at least one beam state;
cause the wireless communication device to determine a transmission resource according to the DCI;
cause the wireless communication device to determine at least one beam state applied to the transmission resource, from the at least one beam state indicated by the DCI, according to transmission information; and
cause the wireless communication device to perform a transmission using the transmission resource.

13. A method comprising:
transmitting, by a wireless communication node to a wireless communication device, downlink control information (DCI) indicating at least one beam state;
causing, by the wireless communication node, the wireless communication device to determine a transmission resource according to the DCI;
causing, by the wireless communication node, the wireless communication device to determine at least one beam state applied to the transmission resource, from the at least one beam state indicated by the DCI, according to transmission information; and
causing, by the wireless communication node, the wireless communication device to perform a transmission using the transmission resource.

14. The method of claim 13, wherein the transmission resource comprises a control resource set (CORESET), a CORESET group, a physical uplink control channel (PUCCH) resource, a PUCCH resource group, a sounding reference signal (SRS) resource, a SRS resource set, or a SRS resource group.

15. The method of claim 13, wherein the wireless communication device to determine the transmission resource according to the DCI, comprises to determine at least one of:
a transmission resource which is associated with the DCI,
a transmission resource group which includes the transmission resource which is associated with the DCI,
a transmission resource identified by a predefined or pre-configured target transmission resource identifier (ID) or a target transmission resource group ID,
a transmission resource identified by a target transmission resource ID or a target transmission resource group ID indicated by the DCI or a medium access control control element (MAC CE) signaling, or
at least one transmission resource which is not identified by a pre-configured target transmission resource ID or a target transmission resource group ID, or by a target transmission resource ID or a target transmission resource group ID indicated by the DCI or a MAC CE signaling.

16. The method of claim 13, comprising:
determining, by the wireless communication device, the transmission resource, according to the DCI and a transmission information.

17. The method of claim 13, comprising determining, by the wireless communication device, the transmission resource, according to the DCI and at least one of:
a transmission resource which is associated with a transmission information corresponding to the at least one beam state indicated by the DCI;
at least one first transmission information associated with the transmission resource that is same as or corresponds to at least one second transmission information which is associated with the at least one beam state indicated by the DCI, or
at least one first transmission information associated with the transmission resource and at least one second transmission information associated with the at least one beam state indicated by the DCI that share at least one transmission information.

18. The method of claim 13, comprising:
causing the wireless communication device to determine the transmission resource, which comprises a control resource set (CORESET), according to:
a CORESET which is associated with at least one transmission information that is same as or corresponds to that associated with the at least one beam state indicated by the DCI; or
causing the wireless communication device to determine the transmission resource, which comprises a physical uplink control channel (PUCCH) resource, according to:
a PUCCH resource which is associated with at least one transmission information that is same as or corresponds that associated with the at least one beam state indicated by the DCI; or
causing the wireless communication device to determine the transmission resource, which comprises a sounding reference signal (SRS) resource, according to:
a SRS resource which is associated with at least one transmission information that is same as or corresponds to that associated with the at least one beam state indicated by the DCI.

19. The method of claim 13, wherein the transmission information comprises or corresponds to a transmission-reception point (TRP), a TRP identifier (ID), a panel, a control resource set (CORESET) pool identifier (ID), a physical cell ID (PCI), a transmission configuration indicator (TCI) state, a TCI state group, antenna group, a beam state or a beam state group.

20. The method of claim 13, comprising:
causing the wireless communication device to determine the at least one beam state applied to the transmission resource from at least one beam state indicated by the DCI which is associated with a transmission information that is same as or corresponds to at least one transmission information associated with the transmission resource.
